(19) United States
(12) Patent Application Publication
(10) Pub. No.: US 2006/0077799 A1
(43) Pub. Date: Apr. 13, 2006

(54) DVD DISK DEVICE WITH VIDEO PLAYBACK

(76) Inventor: Chi-Chih Lee, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,356

(22) Filed: Sep. 7, 2005

(30) Foreign Application Priority Data
Sep. 27, 2004 (TW) 093129382

(51) Int. Cl. G11B 7/00

(52) U.S. Cl. 369/44.27; 369/59.1

(57) ABSTRACT

A DVD device with video playback has a spindle motor to rotate a disc by a pick-up head. An integrated control unit includes a processor, MPEG interface, and I/O interface. The integrated control unit outputs control signals to a motor servo and a pick-up head servo so as to individually control the spindle motor and the pick-up head. The processor help a decoder to modulate the information marks into digital signals. Those digital signals are stored in a memory for forming a decompressed format to output and play. The integrated control unit integrates all the circuits, such as processor, in the DVD device into one chip or a single module to simplify components and the volume.

### BACKGROUND OF THE INVENTION

1. Field of the Invention

The invention relates to a DVD device, and more particularly to the integration of a servo processor, an output interface, and a function of MPEG in a DVD device with video playback.

2. Description of the Prior Art

As shown in FIG. 1, a conventional DVD device doesn't have the function of video playback. The conventional DVD device rotates an optical disc 1 by a motor 2, and radiates a beam onto the optical disc 1 through an optical pick-up head 3. The optical pick-up head 3 detects different light fluxes based on the light reflectivity of the marks on the optical disc 1, and transforms the reflectivity into digital marks, such as 0 and 1, by means of an optical transducer. Then, by the operation of an decoder 4 and a processor 5, those digital marks are modulated into digital signals to be stored into a memory 6 for outputting.

Furthermore, the processor 5 detects the intensity and speed of data signals read by the optical pick-up head 3, and controls the pick-up head servo 7 to adjust the focusing and tracing operation of the optical pick-up head 3. Then, the optical pick-up head 3 is able to trace the data track without aberration to assure the optimum signal strength. Besides, the processor 5 controls a motor servo 8 to adjust the rotational velocity of the motor 2, and the velocity of the optical disc 1 relative to the optical pick-up head 3 will be changed to acquire a proper speed of reading data.

However, the conventional DVD device needs a host 10, such as a computer, to receive digital signals outputting from the memory 6 through an ATAPI interface. By means of the high speed and efficiency of operating capacity, the CPU 11 of the host 10 modulates digital signals into a video format through a MPEG interface, and the video format is outputted via an output interface 13 to play. Therefore, the conventional DVD device only can output digital signals, and doesn't form a MPEG video format itself.

A prior digital video DVD player, although, adds a MPEG's PCB including a processor to play MPEG, the added PCB doesn't be integrated and enlarges the volume of the DVD player. It can't meet the consuming trend of lightness, thinness, shortness, and smallness, and increases the producing cost. Therefore, the conventional DVD device still has the above-mentioned defects to overcome.

### SUMMARY OF THE INVENTION

One object of the invention is to provide a DVD device with video playback, which integrates processors to reduce components and production cost.

It is another object of the invention to provide a DVD device with video playback, which forms a circuit module or a single chip with a reduction in size to avoid enlarging the volume of the DVD device.

It is further object of the invention to provide a DVD device with the function of a built-in video playback to directly play video.

For achieving the above objects, the invention has a spindle motor to rotate a disc by a pick-up head. An integrated control unit includes a processor, MPEG interface, and I/O interface. The integrated control unit outputs control signals to a motor servo and a pick-up head servo so as to individually control the spindle motor and the pick-up head. The processor help a decoder to modulate the information marks into digital signals. Those digital signals are stored in a memory for forming a decompressed format to output and play. The integrated control unit integrates all the circuits, such as processor, in the DVD device into one chip or a single module to simplify components and the volume.

### BRIEF DESCRIPTION OF THE DRAWINGS

FIG. 1 (Prior Art) is a block diagram of control according to a conventional DVD device.

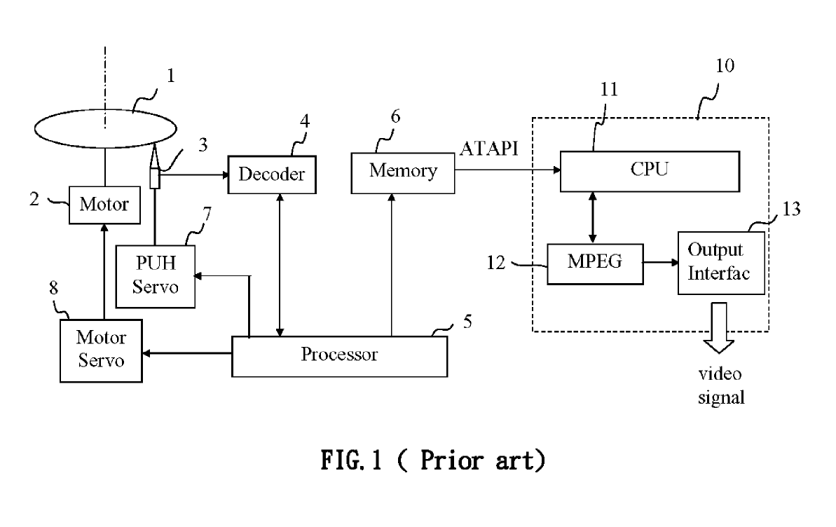

FIG. 2 is a block diagram of control according to the invention.

### DETAILED DESCRIPTION

Other objects, features, and advantages of the invention will become apparent from the following detailed description of the preferred but non-limiting embodiments. The following description is made with reference to the accompanying drawings. Anyone who is skilled in related technology would be able to understand and implement the technology accordingly.

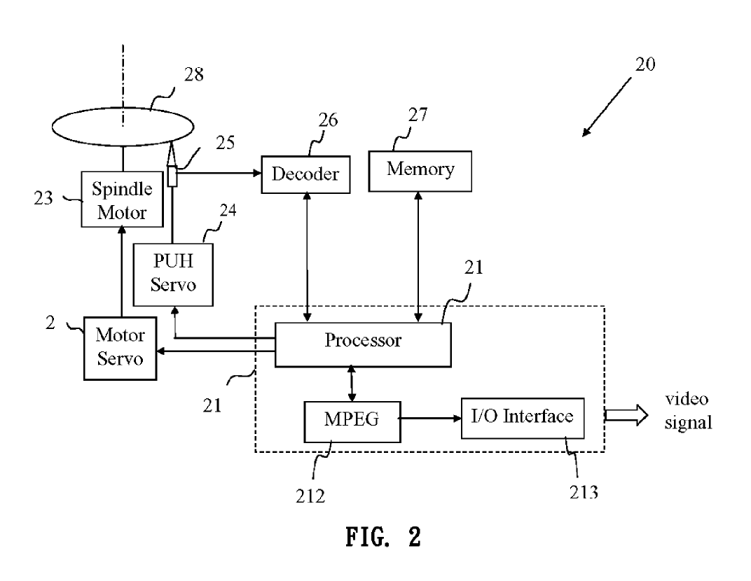

Referring to FIG. 2, the invention is a DVD device 20 with video playback including an integrated control unit 21, a motor servo 22, a spindle motor 23, a pick-up head servo 24, a pick-up head 25, a decoder 26, and a memory 27. The integrated control unit 21 mainly outputs a control signal to control the spindle motor 23 and the pick-up head 25 which reads the information marks on a disc 28, and modulates the information marks into digital signals to store in the memory 27 for playing.

The integrated control unit 21 includes a highly efficient processor 211, a MPEG interface 212, and an I/O interface 213. When the DVD device 20 rotates the disc 28 by the spindle motor 23, the pick-up head 25 projects a beam onto the disc 28. The information marks on the disc 28 reflects the beam back to the pick-up head 25. A transducer (not shown) in the pick-up head 25 transforms the beam into a electric signal, and by means of the operation of processor 211 in the integrated control unit 21, the decoder 26 modulates the electric signal into a digital signal to store in the memory 27.

The processor 211 in the integrated control unit 21 judges the intensity and speed of signals read by the pick-up head 25 to control the pick-up head servo 24 so as to adjust the focusing and tracing operation of the pick-up head 25. Then, the pick-up head 25 is able to trace the data track to precisely read the information marks. Meanwhile, the processor 211 controls the motor servo 22 to adjust the rotational velocity of spindle motor 23, and the velocity of the disc 28 relative to the pick-up head 25 will be adjusted to acquire a proper speed of reading data. Thus, the proper speed of reading data avoids exceeding the processing load of the decoder 26, and prevents information from losing and discontinuing.

When the DVD device 20 connects an audio-visual equipment (not shown), such as monitor or display device, the processor 211 in the integrated control unit 21 delivers the digital signals stored in the memory 27 to the MPEG interface 212. The MPEG interface 212 decompressed digital signals, and forms a video format. Then, the I/O interface 213 transfers the video format to play. The DVD device 20 can directly play video without other hosts. Therefore, the single processor 211 integrated in the integrated control unit 21 is used for not only controlling the DVD device 20 to read and decode the information, but also transferring the information into a MPEG format to directly output and play. Thus, the DVD device 20 reduces one processor and production cost.

Besides, the highly efficient processor 211, the MPEG interface 212, and the I/O interface 213 included in the integrated control unit 21 can be integrated into a single control circuit module or a system on one chip to reduce components and the volume of circuits. The integrated module prevents the crowded DVD device 20 from generating handicaps of arrangement and operation, and enables the volume of the DVD device 20 to continue the development of lightness and thinness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A DVD device with video playback comprising:
a spindle motor rotating a disc;
a pick-up head reading marks on the disc;
a decoder modulating the marks into digital signals;
a memory storing the digital signals; and
an integrated control unit outputting control signals to control the spindle motor and the pick-up head, assisting the decoder in modulating the marks by means of the function of operating, and transforming the digital signals into video format to output.

2. The DVD device with video playback of claim 1, wherein the integrated control unit further comprises a processor having the function of operation and outputting the control signals.

3. The DVD device with video playback of claim 1, wherein the integrated control unit further comprises a MPEG interface which transforms the digital signals into video format.

4. The DVD device with video playback of claim 1, wherein the integrated control unit further comprises an I/O interface.

5. The DVD device with video playback of claim 1, further comprising a motor servo receiving control signals from the integrated control unit to control the rotation of the spindle motor.

6. The DVD device with video playback of claim 1, further comprising a pick-up head servo receiving control signals from the integrated control unit to control the pick-up head.

7. The DVD device with video playback of claim 1, wherein the integrated control unit forms a single control circuit module.

8. The DVD device with video playback of claim 1, wherein the integrated control unit forms a system on one chip.
